(19) United States
(12) Patent Application Publication
(10) Pub. No.: US 2011/0047406 A1
(43) Pub. Date: Feb. 24, 2011

(54) SYSTEMS AND METHODS FOR SENDING, RECEIVING AND MANAGING ELECTRONIC MESSAGES

(75) Inventors: Michael Smith, Oradell, NJ (US); Greg Lowe, River Vale, NJ (US)

Correspondence Address: PATTON BOGGS LLP, 8484 WESTPARK DRIVE, SUITE 900, MCLEAN, VA, 22102, US

(73) Assignee: General Devices, Ridgefield, NJ (US)

(21) Appl. No.: 12/793,443

(22) Filed: Jun. 3, 2010

Related U.S. Application Data
(60) Provisional application No. 61/236,410, filed on Aug. 24, 2009.

(51) Int. Cl. G06F 11/14; G06F 15/16; G06F 11/07; H04L 9/00

(52) U.S. Cl. 714/4; 709/206; 714/57; 713/150; 714/E11.023; 714/E11.113

(57) ABSTRACT

Systems and methods for electronic message may include receiving information from a sending device. The information may include a prioritization determination, initial receiving device destinations, alternate receiving device destinations, and a determination of a plurality of responses to message delivery failures from the sending device. Data may be attached to the message before encrypting and sending. Status information about the message may be received, provided to the sending device, and updated. If message delivery failure occurs, the message may be sent to one or more alternate receiving device destinations. Status information about the message may again be received, provided to the sending device, and updated. Message and status information may be stored in a database.

### CROSS-REFERENCE TO RELATED APPLICATIONS

This application claims the benefit of U.S. Provisional Patent Application No. 61/236,410, filed Aug. 24, 2009; the content of which is incorporated by reference herein in its entirety.

### FIELD OF THE INVENTION

The present invention relates to the field of electronic messages, and, more specifically, to sending, receiving and managing electronic messages.

### BACKGROUND OF INVENTION

Multiple ways of communicating voice, text, data and images separately or in combination are well-known in the art of messaging and communications. The oldest and most common forms are: conventional mail for communicating text, data or images in a visual format; and telephone, for communicating voice messages. Security of such messages is accomplished by a variety of commercially available scrambling and encoding methods. A variety of technologies exist for sending electronic forms of text, data and images information over conventional analog and digital telephone systems by means of modulators (modems) that convert electronic data to formats suitable for transmission via standard telephone systems.

E-mails and text messaging are more modern, computer-based methods of communicating much, or all, of the abovementioned information types. The typical e-mail messaging system includes: a general-purpose computer-type sending device with a dedicated user interface; a transmission system, such as the Internet; and a general-purpose computer-type receiving device with a dedicated user interface. Text messaging employs a similar system using devices focusing primarily on wireless communications, such as cell phones and personal digital assistants (PDAs). All such systems have built-in message arrival alerting systems and encryption systems.

Current e-mail systems permit the user to enter text information as well as attach almost any form of electronic information, including text, data and images. Various user screens permit the user to enter and review such information prior to transmission. Various systems are also provided to enter a destination address (e-mail address) either by direct keyboard entry or selection from a list of predefined e-mail addresses. Various systems are also provided for announcing the arrival of messages, displaying the delivery status of the message, as well as requesting acknowledgement information from the addressee.

Text messaging or Short Message Service (SMS) is a feature available with most digital mobile phones as a way to send quick messages to one or more recipients using a digital mobile phone. Input systems vary with the phone, such as standard 12 button keypad or full keyboards. The number of characters in SMS messages may be restricted. Messages transmitted via SMS are sent to an SMS Center (SMSC) and then relayed to the recipient. If the message does not reach the recipient on the first attempt, the SMSC tries again with the number of retries varying with the service provider. SMS message delivery is not guaranteed, and is a “best effort” protocol.

Another technology used by mobile phones for message and multimedia content delivery is Multimedia Message Service (MMS). Using MMS users can send text messages, sound files, pictures, movies, or any other digital information using a variety of protocols that are then received by a mobile phone. To send a message via MMS, a TCP/IP connection to an MMS Center (MMSC) is established, which then performs an HTTP POST of the encoded MMS message to the MMSC. The MMSC receives the message and authenticates the message sender. The MMSC stores the contents of the message and makes the contents available via a dynamically created URL. The MMSC then generates an SMS message to the recipient with a link to the content. The recipient must then initiate an HTTP GET to retrieve the message content.

The above mentioned systems and methods, while performing many of the basic tasks of communicating some or all of the information types, possess several shortcomings insofar as message tracking, information security, documentation, message arrival alerting and responsively incorporating additional means of communicating information. For example, whereas all of the abovementioned communications methods possess one or more message arrival alerting means, all are limited by one or more significant constraints. Commonly used e-mail, by far the most advanced form of messaging available to users (outside of government, military or other “special purpose” applications), has an array of responses limited to audio responses, a small range of visual indicators, and largely unable to responsively adapt in accordance with pre-defined alternative delivery or announcement means. While e-mail protocols permit the sending of voice messages via WAV files and similar electronic formats, present day e-mail applications lack a convenient way of directly creating a voice message from the message creation user-screen. The ability to document events (incoming or outgoing messages) is restricted to information available only to the sender and the receiving parties and not otherwise available to others. The ability of e-mail systems to track and announce message status is primitive, reactive, and not an intrinsic part of the message creation process. Once a message is sent, there is no way to gain additional information regarding status until the message is received by the receiving device and/or is opened at the destination. Another example of the limitation of existing technology is the inability of most systems to react to message delivery failures in a user-defined and task-specific manner.

Needs exist for improved systems and methods for sending, receiving and managing electronic messages.

### SUMMARY OF INVENTION

Certain embodiments of the present invention may provide a system for sending, receiving and managing electronic messages.

Systems and methods for electronic message may include receiving information from a sending device. The information may include a prioritization determination, initial receiving device destinations, alternate receiving device destinations, and a determination of a plurality of responses to message delivery failures from the sending device. Data may be attached to the message before encrypting and sending. Status information about the message may be received, provided to the sending device, and updated. If message delivery failure occurs, the message may be sent to one or more alternate receiving device destinations. Status information about the message may again be received, provided to the sending device, and updated. Message and status information may be stored in a database.

Embodiments may include assigning a digital message priority code to the message, and/or assigning a digital message destination/recipient code to the message. The database may store date, time and distribution information related to the message and any forwarding and distributing associated with the message. The database may store: (i) time of receiving the message from the sending device; (ii) time of delivery of the message to the one or more initial receiving devices; (iii) time of opening of the message by the one or more initial receiving devices; and (iv) identity of all initial receiving devices associated with the message. The database may store: (i) time of receiving the message from the sending device; (ii) time of delivery of the message to the one or more alternate receiving devices; (iii) time of opening of the message by the one or more alternate receiving devices; and (iv) identity of all alternate receiving devices associated with the message. Message delivery failure may include: (i) failure to send the message; (ii) failure of the one or more initial receiving devices to receive the message; (iii) failure of the one or more alternate receiving devices to receive the message; (iv) failure of the one or more initial receiving devices to open the message; or (v) failure of the one or more alternate receiving devices to open the message. Embodiments may include alerting the sending device of message delivery failure. The alerting may be auditory alerts. Embodiments may include identifying embedded codes in the message related to the message prioritization, determination of a plurality of responses, and encryption. Certain embodiments may include responding the embedded codes.

Systems and methods for sending and tracking electronic messages may include a processor and memory for executing the steps including: receiving a selection from a user of one or more initial message destinations for a message; receiving a selection from the user of one or more responses to message delivery failure; receiving a selection from the user of a message priority; receiving a selection from the user regarding acknowledgement preferences; creating the message using the one or more initial message destinations, the one or more responses to message delivery failure, the message priority, and the acknowledgement preferences; attaching one or more data files to the message; receiving a notification from the server regarding message delivery to the one or more initial message destinations; receiving a notification from the server regarding message delivery failures; communicating with a server for continuously tracking status of the message; and if requested by the user, receiving an acknowledgement including identification of the receiving user at the one or more initial message destinations.

Embodiments may include providing a set of status indicators on a control screen indicting that the message has (i) been sent; (ii) been delivered; (iii) been opened by the one or more initial message destinations; and (iv) been acknowledged by the one or more initial message destinations. Embodiments may include providing auditory alarms in response to message delivery failures. Message delivery failure may include: (i) failure to send the message; (ii) failure of the one or more initial message destinations to receive the message; (iii) failure of one or more alternate message destinations to receive the message; (iv) failure of the one or more initial message destinations to open the message; or (v) failure of the one or more alternate message destinations to open the message. In certain embodiments, one or more responses to message delivery failure may include one or more alternate message destinations. Embodiments may include providing a set of status indicators on a control screen indicting that the message has (i) been sent; (ii) been delivered; (iii) been opened by the one or more alternate message destinations; and (iv) been acknowledged by the one or more alternate message destinations.

Systems and methods for receiving and tracking electronic messages may include: a processor and memory for executing the steps including: receiving a message from a server; decrypting the message; announcing the message in accordance with a level of priority embedded within the message; if requested by an acknowledgement request embedded within the message, sending an acknowledgement to the server; sending information regarding opening the message to the server; sending information regarding reading the message to the server; sending a response to the message to the server; and receiving status updates regarding the message from the server.

Embodiments may include providing a set of status indicators on a control screen indicting that (1) the message was received; and (2) reply/forwarded messages sent have (i) been sent; (ii) been delivered; (iii) been opened by another device ; and (iv) been acknowledged by another device. The announcing may be an auditory alarm.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention.

FIG. 1 is a block diagram showing an entire messaging system, according to a certain embodiment.

FIG. 2 is a diagram of a computer-type message creating/receiving point, according to a certain embodiment.

FIG. 3 is a diagram of interactions of message creating, sending, managing and receiving devices, according to a certain embodiment.

FIG. 4 is a flow chart showing a method for controlling creation and sending of messages, according to a certain embodiment.

FIG. 5 is a flow chart showing a method for controlling receiving of messages, according to a certain embodiment.

FIG. 6 is a flow chart showing a method for responding to variable message sending and delivery conditions, according to a certain embodiment.

### DETAILED DESCRIPTION OF THE EMBODIMENTS

In many situations, there is a need to quickly compose and send secure, prioritized electronic messages and provide the sender with a comprehensive method of notifications that serve to inform the sender that the messages were sent, received and delivered to the desired recipient(s), and that the messages were documented insofar as at least content, time of sending, time of delivery and time of opening by the recipient(s). The messages to be sent may include voice, text, data or image information, and may go to one or to more destinations or individuals.

Embodiments of the present invention may allow a single user to send a communication to multiple recipients when there is a need for confirmation, rerouting in case of delivery failure, status tracking, and knowledge of whether action has been taken regarding the communication. This may avoid redundancy, the need to resend the communication and may reduce personnel requirements.

Embodiments of the present invention may include a system for creating messages, prioritizing messages, sending messages, documenting all message transactions, a system for receiving messages, and a system of alerting a recipient to arrival of the messages.

As will be appreciated by one of skill in the art, aspects of the present invention may be embodied as a method, data processing system, or computer program product. Accordingly, aspects of the present invention may take the form of an embodiment that is entirely hardware or an embodiment combining software and hardware aspects, all generally referred to herein as system. Furthermore, elements of the present invention may take the form of a computer program product on a computer-usable storage medium having computer-usable program code embodied in the medium. Any suitable computer readable medium may be utilized, including hard disks, CD-ROMs, optical storage devices, flash RAM, transmission media such as those supporting the Internet or an intranet, or magnetic storage devices.

Computer program code for carrying out operations of the present invention may be written in an object oriented programming language such as JAVA, C#, Smalltalk or C++, or in conventional procedural programming languages, such as the Visual Basic or “C” programming language. The program code may execute entirely on the user's computer, partly on the user's computer, as a stand-alone software package, partly on the user's computer and partly on a remote computer, or entirely on the remote computer. In the latter scenario, the remote computer may be connected to the user's computer through a local area network (LAN) or a wide area network (WAN), or the connection may be made to an external computer (for example, through the Internet using an Internet Service Provider).

Aspects of the present invention are described with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, server, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer, server or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks, and may operate alone or in conjunction with additional hardware apparatus described herein.

In an embodiment, the present invention may be a system or method for transferring messages containing voice, text, data and image information in a secure manner from a sending device, to a server, then to one or more receiving device(s), while also providing a plurality of means to enhance the surety of delivering the message to its intended destination. The sender may select a destination, a response (or set of responses) to message delivery failure, a message priority, and then may create the message by voice, text, or data or image attachment. Upon sending the message, the outgoing information, along with coded message management instructions, may be encrypted and then sent to the server for permanent recording, distribution and tracking In all phases of message delivery, the status of the message may be continuously tracked, with message status information continuously recorded by the server and reported back to the sending device. Upon delivery to the destination's receiving device, a notification is sent to the sender advising of message delivery and, if so requested by the sender, an acknowledged including the identity of the person at the receiving device. The coded instructions containing the sender-selected priority of the message may be identified by the sending device and responded to accordingly. In the event the message has not been delivered to the destination device and/or the destination device fails to open the message and/or the acknowledgement request is not fulfilled, the server may redirect the message to one or more alternate destinations and report this information to the sender by the previously described systems and methods.

A set of color-coded icons on the sender's control screen, along with suitable audible alerts, may indicate that a message has (i) been sent (left the sender's computer); (ii) been delivered (received by the destination(s)/recipient(s); (iii) been opened by the destination(s)/recipient(s); and/or (iv) been acknowledged by the destination(s)/recipient(s). The status indicators may change in response to automatic periodically updated information provided via the network and server.

Similarly, a set of color-coded icons on the destination(s)/recipient(s) control screen, along with suitable audible alerts, may indicate that (i) incoming messages have been received and reply/forwarded messages sent from destination(s)/recipient(s) computers have (ii) been sent (left the destination(s)/recipient(s) computer); (iii) been delivered (received by new destination(s)/recipient(s); (iv) been opened by new destination(s)/recipient(s); and/or (v) been acknowledged by new destination(s)/recipient(s). The status indicators may change in response to automatic periodically updated information provided via the network and server.

Systems and methods according to certain embodiments may include (a) hardware for a system for a sender to create a voice, text, data, image and other electronic forms of information of messages; (b) a method to convert the message into a digital data format suitable for management by conventional digital data mechanisms; (c) a method for the sender to prioritize the messages; (d) a method for the sender to select the message's destinations; (e) a method for the sender to determine a plurality of responses to message delivery failures; (f) a method of encrypting outgoing information associated with the message; (g) a method for both the sender and the recipient to view the status of the message(s); (h) a method to communicate the messages within an electronic communications network; (i) a centralized means (server) to receive, store and distribute messages and identify the status of both the sent messages and the receiving devices; (j) a method for the server to identify various codes embedded within the messages data format and respond to the codes; (k) a system whereby the sent message may be received, announced, displayed, played, recorded, distributed and otherwise utilized at the messages destination; (l) a method to announce the arrival of messages at their destinations in accordance with their level of priority; (m) a method to decrypt an encrypted message at the destination; a method to alert the destination of the status of messages; (n) a method to automatically manage older messages to both the sender's and the destination's status alerting and status indication reporting screens.

An electronic communications network with a server may include “member” computers, telephones, Personal Digital Assistance and other suitably equipped digital communications devices that are (i) known to the server as member computers, and whose electronic address is stored within the server; and (ii) other computers, telephones, Personal Digital Assistance and other suitably equipped digital communications devices that are not known to the server as “members” and whose electronic address is not known to the server.

A set of user controls may include: (i) a create message command; (ii) a message status command; (iii) a help command; (iv) a destination setting command; (v) a send command; (vi) a voice message record command; (vii) a document attach command; (viii) a save command; (ix) a cancel command; (x) a priority command; (xi) a message delivery failure instruction command; (xii) as well as other commands needed to fulfill the needs of the other user commands.

A sender may select a priority for the message that is related to the relative importance of the message. A digital message priority code may be assigned to the message in accordance with the user-selected message priority. The message priority code may be located in a pre-assigned location in the message's digital data format. Codes may also be provided for a message destination, encryption, status, etc.

Embodiments of the present invention may also process and record conversations. Conversations may include all replying and/or forwarding associated with the message.

In certain embodiments, coded information and status flags may be embedded within and associated with the message describing (i) time of message arrival from sender computer; (ii) time of delivery to destination/recipient computer; (iii) time of opening of the message by destination(s)/recipient(s); (iv) identity of all destinations associated with the message; and (i)-(iv) of all conversations associated with the message.

The may provide for the (i) receipt and storage of messages and embedded information from a sending member; (ii) forwarding of stored messages in accordance with the message's embedded information; (iii) performing special instructions as determined by the stored message's embedded coded information and status flags.

A plurality of responsive actions may be provided in the event a message fails to be delivered to the recipient because of (i) failure to send from the sending device; (ii) failure to be received by the destination device(s); failure to be opened at the receiving device. The software's message delivery failure actions may include: (i) a sender selected alert; (ii) a sender selected alternate destination(s).

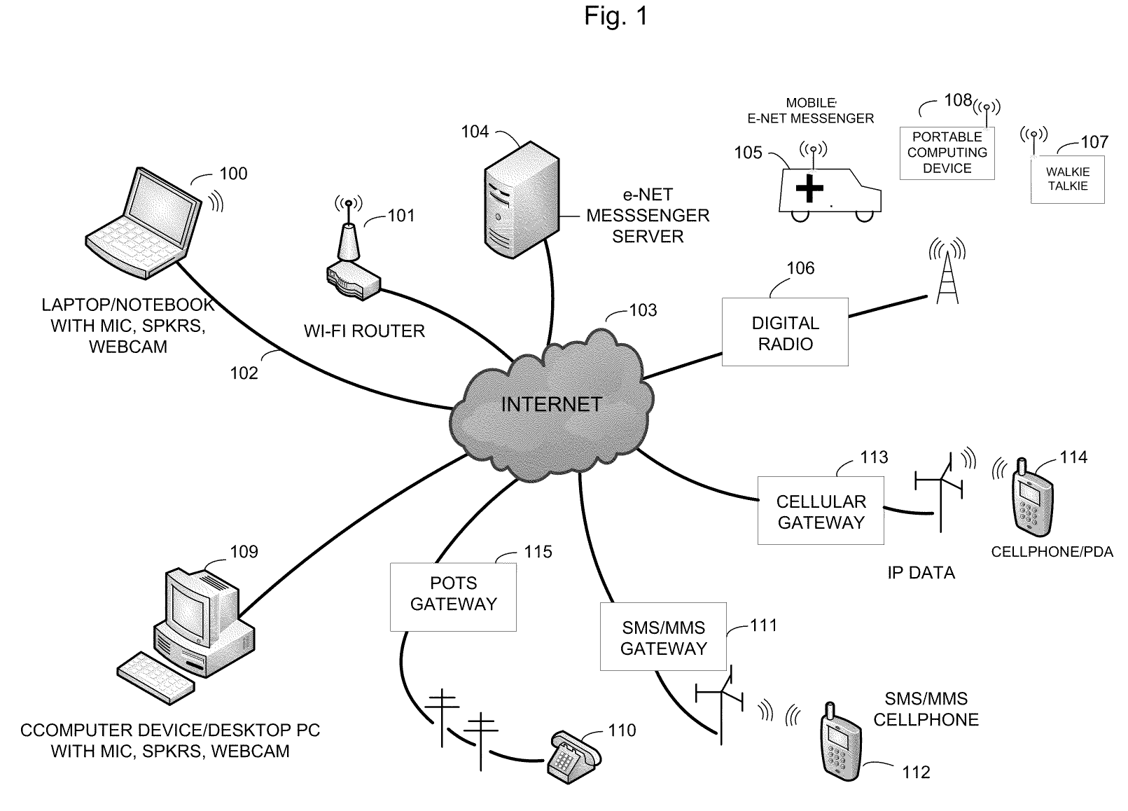

FIG. 1 is a high level diagram of an embodiment of the present invention illustrating several applications. Various endpoints are shown, along with a server 104 and an interconnecting network 103. In addition to the Internet, connections between the various devices may also be an intranet or LAN (Local Area Network).

A portable computing device 100, such as a laptop, tablet, netbook, etc., may be connected to the network 103 via a wired 102 or wireless connection through a WiFi router 101 or any other standard wireless connectivity system. The server 104 may be responsible for passing messages between the various sending and receiving devices as well as recording and otherwise managing the messages. The physical location of the server 104 may be irrelevant, as long as the server 104 has connectivity to the network 103.

A portable/mobile computing device 105 may be located in a vehicle with wireless connectivity provided by a mobile digital radio 106. Wireless connectivity may also be through a handheld “walkie talkie” 107 or integration within a portable computing device 108. A standard desktop computing device 109 may be connected to the network. Messages may also be sent or received through a conventional telephone 110 system (Plain Old Telephone System or “POTS”) gateway 115 to or from other POTS devices without the need for a computing device. Using this POTS gateway, phone tree message distribution is accomplished. A Short Message Service (SMS)/Multimedia Messaging Service (MMS) gateway 111 may be connected to the network 103 through which simple text or multi-media messages may be sent and or received using a standard cellular telephone 112. A cellular data gateway 113 may be connected to the network through which data may be passed between the server 104 and a portable device, such as a smart phone or Personal Digital Assistant (PDA) 114. Since the cellular data gateway 113 may not rely on existing messaging protocols, such as SMS and MMS, the device 114 may not be capable of supporting message delivered/opened status. Other delivery systems and methods and receiving endpoints may be used depending on particular situations.

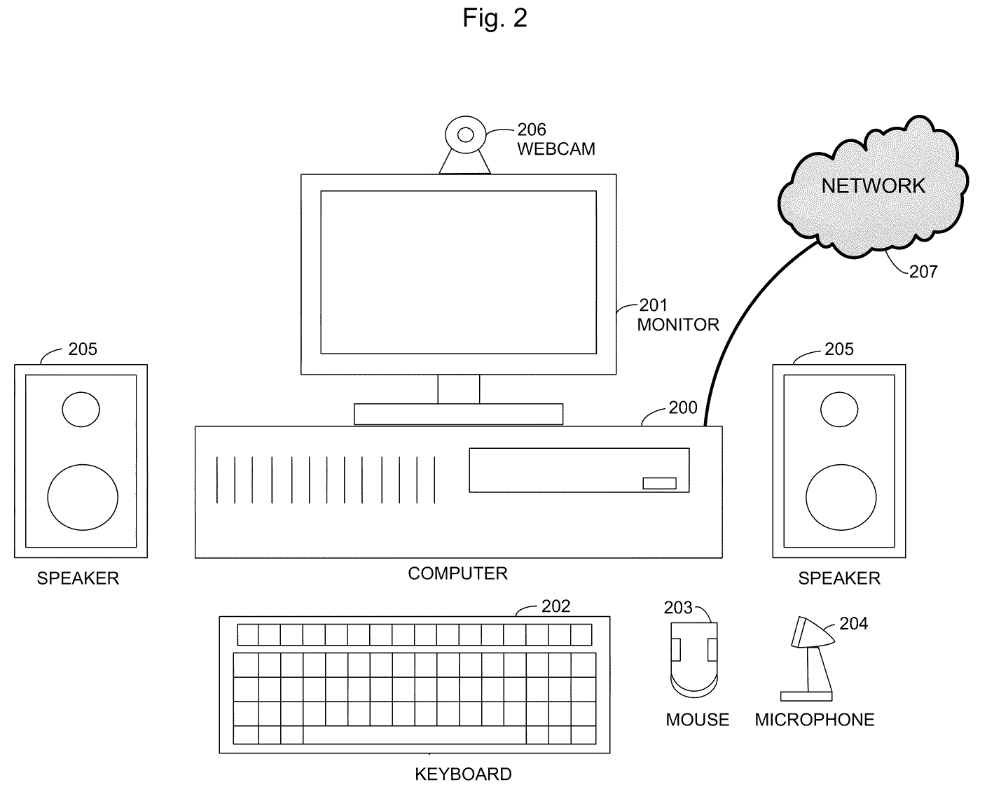

FIG. 2 depicts a typical computer-type message sending/receiving system including a standard CPU unit 200 and monitor 201. Control may be provided by a keyboard 202, a mouse 203, a touch screen on the monitor, voice input through microphone 204, or any other standard computer inputting system or method. Voice messages may be input via microphone 204 and output via speakers 205. Still images and/or motion video may be captured and transmitted in a message via camera 206. Many forms of input are possible, such as, but not limited to, trackball, document scanner, pen based digitizer pad, joystick, touchpad, barcode scanner, etc. The above described sending/receiving means are connected to a network 207.

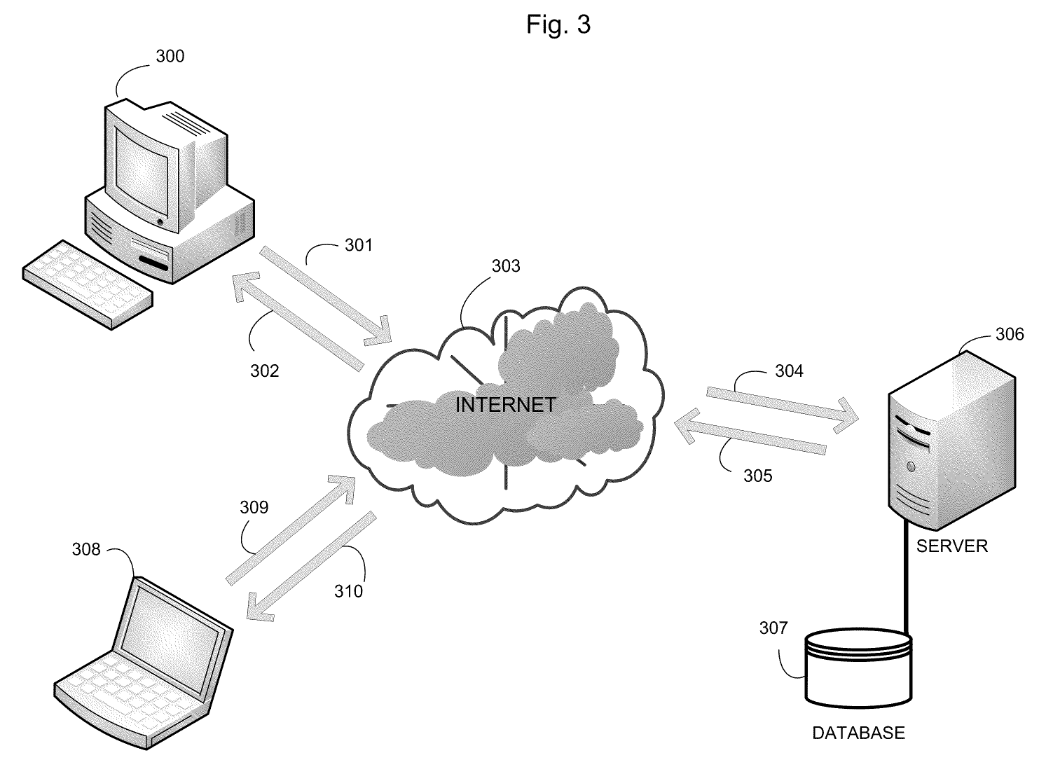

FIG. 3 is a graphical illustration of a certain embodiment for delivering messages from a sending device 300 to a receiving device 308. A message originating at the sending device 300 may communicate with a network 303 via paths 301, 302. The message may then be in communication with a server 306 via paths 304, 305. In response to a poll from the receiving device 308, the server 306 may communicate the message to the receiving device 308 via paths 309, 310.

The server 306 may perform various functions such as (i) managing the overall system by receiving and processing periodic communications (polling) from each member on the network so as to ascertain its availability to send or receive messages; (ii) managing transmission and documentation of individual messages by receiving them, storing them in one or more databases 307, sending them to their destinations and providing the message delivered/opened/acknowledge status reports to the sending device 300, and; (iii) distributing records of activity and stored information to authorized destinations.

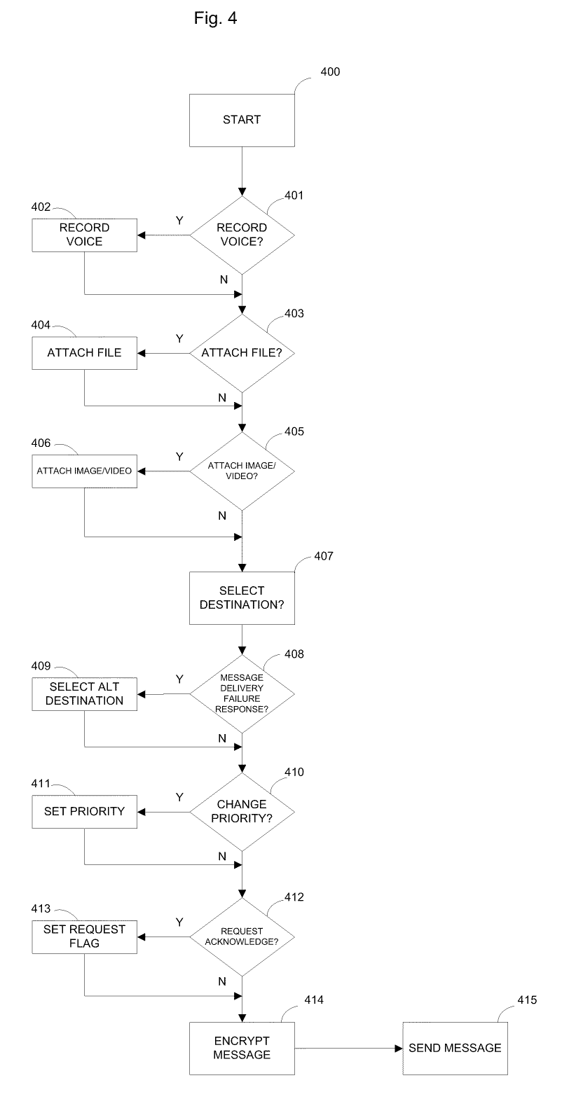

FIG. 4 is a flow chart illustrating user-level message creation and sending. Upon starting a message 400, content may be entered by a user through any or all of the following methods: a voice recording 401, 402; attachment of a document or file 403, 404; or attachment or creation of a still or moving image 405, 406. The entered content may be received by a processor and/or memory in a sending device. A destination 407 may be entered by the user and, if so desired, an alternate message-delivery-failure destination 408, 409 is entered. This information is also then received by the processor and/or memory in the sending device. A message priority 410, 411, message acknowledgement request 412, 413 or other parameters may also be entered and received by the sending device. Prior to sending the message 415, the outgoing information may be encrypted 414.

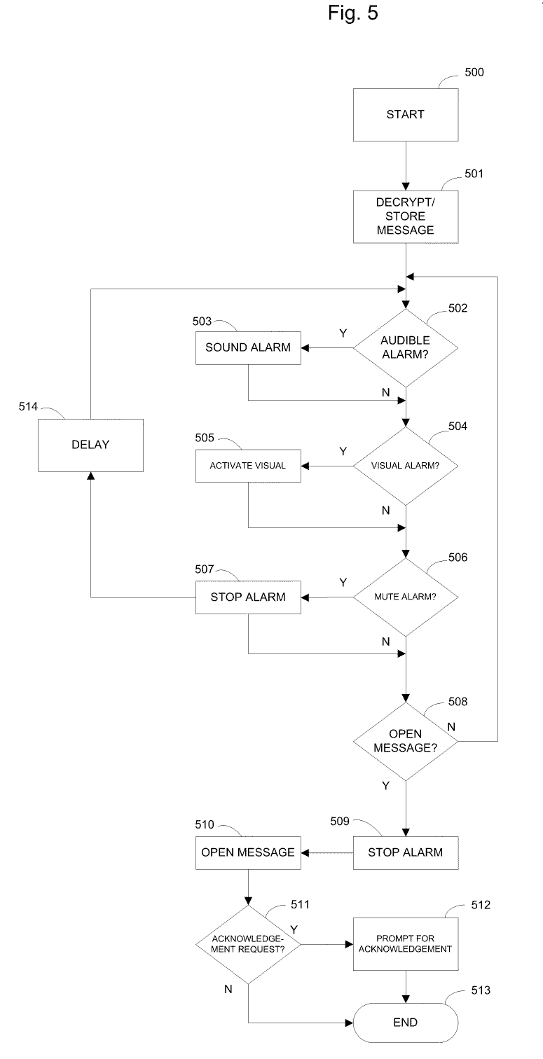

FIG. 5 is a flow chart illustrating user-level message receiving. Upon receiving a message 500, the incoming information may be decrypted 501 and/or stored within the receiving device. An audible alert 502, 503 and/or visual alert 504, 505 may be initiated in accordance with encoded message priority instructions. The alert may be temporarily muted 506, 507 if desired by a user. A delay 514 may also be used for the alarm. When the message is opened 508, the alarms may be canceled 509 and the information may be opened and/or displayed 510. If an acknowledgement request had been made by the sender 511, the recipient may be prompted to enter an identifier, such as a name or ID number 512, prior to ending of the receiving session 513.

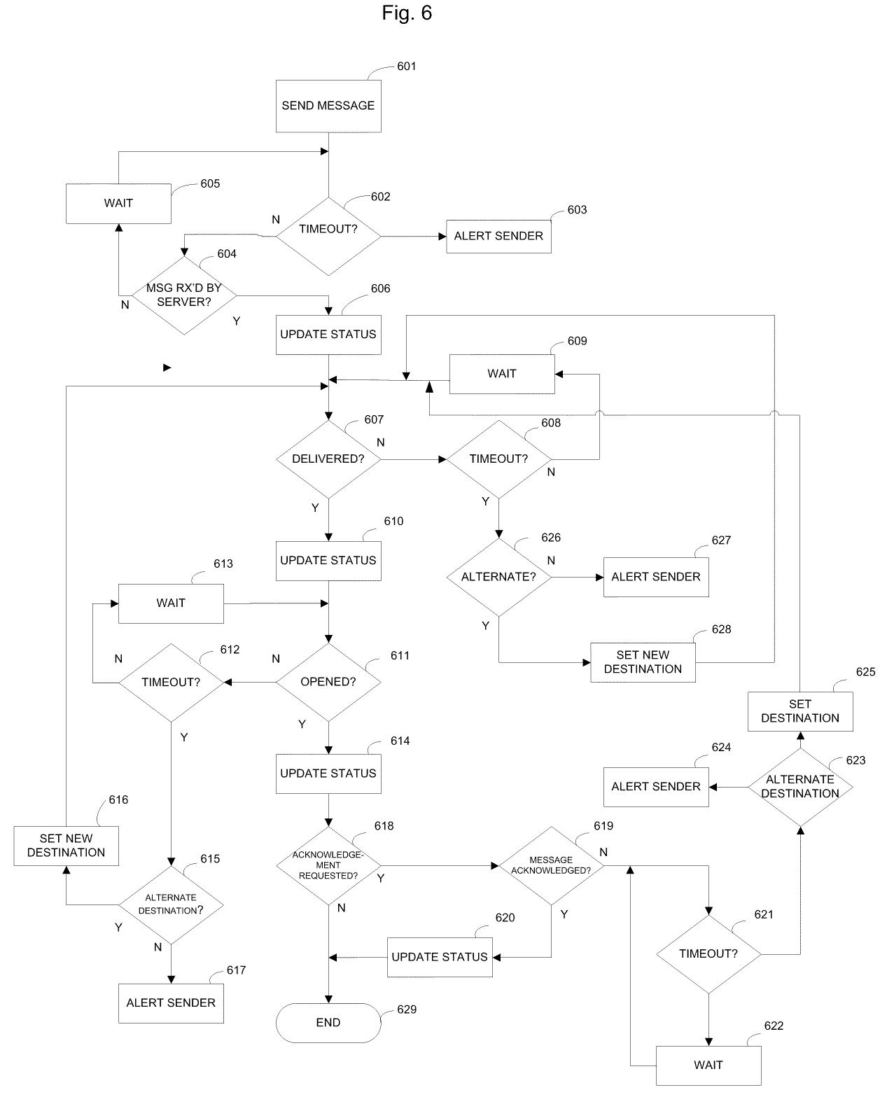

FIG. 6 is a flow chart illustrating responding to variable message sending and delivery conditions. When a message is sent from a sending device 601, it may be initially transmitted to a server 604. A timer 602 may be initiated within the sending device. Upon the messages' receipt by the server 604, the server 604 may notify the sending device and cancel the timer 602. An alert 603 may be initiated by the timer 602 in the event the timer 602 is not reset prior to timing out after a waiting period 605, thus notifying the sender that the message sending process was unsuccessful.

If the message is transmitted successfully, the message status 606 may be updated at the sending device 601 to reflect successful transmission to the 604 server. The server 604 may stored the message and the associated logistical information, such as, but not limited to, identification of the sender, time of sending, time of receiving by server, etc. The message may be stored in a server database and may await delivery of the message 607.

In certain embodiments, if a user selected an alternate destination(s), and the message is undelivered to the primary destination after a configurable timeout 608, a new destination may be set 628 and message delivery is attempted again. If the message times out 608 after waiting 609, and there is no alternate set 626, the sender may be alerted that the message delivery was unsuccessful 627.

If the message is delivered to the destination successfully, the message delivered status 614 may be updated 610 accordingly. The system may wait for the recipient to open the message 611. If, after a configurable timeout 612 the user does not open the message, if there is an alternate destination available 615, the system may attempt to deliver the message to the alternate destination 616. If the message is not opened within the time out period 612 after waiting 613 and there is no alternate destination set, the sender may be alerted that the message delivery was unsuccessful 617.

If the message is delivered and opened successfully, the system may update the status 614 and then check to see if an acknowledgement was requested 618. If no acknowledgement was requested, the message delivery may be complete 629. If an acknowledgement was requested 619 and the message is acknowledged, status is updated 620. If an acknowledgement was requested 619 and no acknowledgement is received, the system may wait 622 for a configurable timeout 621 for the recipient to acknowledge the message.

If the recipient does not acknowledge receipt of the message within the timeout 621 and there is an alternate destination available 623, a message delivery attempt may be made to the alternate destination 625. If the recipient does not acknowledge receipt of the message within the timeout and there is no alternate destination available, the sender is alerted that the message was not delivered 624.

In certain embodiments, the message is automatically encrypted and/or protected to insure security and/or HIPAA compliance.

The following are exemplary illustrations of how embodiments of the present invention may be used. The examples are not intended to be limiting.

### EXAMPLE 1

Ambulances may be equipped with portable computing devices. A hospital may be managing an emergency medical service ST-Segment elevation myocardial infarction (STEMI) call in a remote town. STEMI may be verified by an emergency department physician (EDP) at the hospital from a transmission of a 12-lead electrocardiogram (ECG) along with associated vital signs monitoring data. Weather conditions may force arrival time to exceed 60 minutes. As such, the destination hospital may be changed to a closer regional medical center, which has a catheterization lab.

The EDP managing the call at the hospital may forward the 12-lead report along with a call-summary report (with voice narration) directly from the hospital computing device to a computing device at the regional medical center using systems and methods described above. The message may include patient information.

Upon receipt of the message, the computing device in the regional medical center may set off an alarm. A cardiologist may respond and open the message in an application that receives, displays, and prints the 12-lead and also opens the hospital's call-summary report. Because the message may also include an identity request, the cardiologist may type their name into the request form and close the form, automatically sending an acknowledgement back to the hospital. The cardiologist may read the call summary report, listen to the EDP's detailed voice narrative, review the 12-lead report, ready the catheterization lab for the incoming patient, and coordinate the emergency department (ED) bypass.

The hospital may receive a confirmation according to the system and method described above on their computing devices of both the time that the message was received at the regional medical center, when it was accepted, and the identity of the person that received the report.

While this was happening, in accordance with State Health Department procedures, an entry may be automatically made in the state's STEMI Registry, automatically attaching a reference number so that all aspects of the event could be retrieved for later analysis. Therefore, the system and method may document each aspect of the transaction through a server for a permanent record of the event.

### EXAMPLE 2

A large scale, multi-casualty emergency situation may prompt many people to show up in an emergency department seeking information about missing family members and loved ones. Many individuals may have photographs of the casualties. One of the missing casualties may be a diabetic child. An individual may collect the photos and personal information of the missing patients. These may be scanned and made available to the hospital's workstation via the hospital network. An individual may obtain identifying characteristics from the child's parents.

The individual may record a brief voice-mail message on a portable computing device describing what is going on and asking those at other emergency departments to be on the lookout for the missing people. The individual may make special mention of the missing diabetic child and provide a verbal description of the child. She/he also asks that each ED take photos of any patients that might be considered missing and send the photos and any other information back for redistribution. Photos and personal information may be attached to a message sent to all the nearby hospitals via a pre-established distribution list. The computing devices of each facility on the distribution list may alarm to inform the staff of the incoming communication. The message is clear and unambiguous and contains the photos and personal information.

At a certain receiving hospital, the alarm may be received, the message replayed and the photos viewed. The missing child may be identified. A computing device may be used to record a voice response and reply to the original hospital to inform them about the missing child, and acknowledging the special medical needs of the child. The photos of the missing casualties may be printed and posted on a bulletin board for others to see.

As other receiving hospitals identify missing patients and send photos back to the originating hospital, a compilation of photos and other information is then distributed to all those involved in the incident (hospitals, police stations and fire houses).

### EXAMPLE 3

All ambulances and health care facilities may be equipped with systems and methods as described above. A call may be received at a relatively distant hospital concerning a six year old male experiencing acute breathing difficulty. Medics may be familiar with the patient and know there are complicating factors. Because of this they may be not only uncertain as to what they should do, but also concerned because they know that a clinic is only ten minutes away, and although it has a highly competent emergency room physician, the clinic does not have a pulmonologist.

Vital signs may be taken in the ambulance and transmitted to the hospital for viewing. After being apprised of the situation by the medics and looking at the vital signs, an emergency room physician may elect to call in a pulmonologist.

The pulmonologist may prefer to assess the situation personally and may want to see the patient. The ambulance may be able to connect via cellular broadband. The system may be able to determine optimal image transmission settings for this communications means and the pulmonologist may be able to adequately visualize the patient through a low frame rate image. After seeing the patient, the pulmonologist may be able to take into account the complicating factors and instruct the medics to pursue a more aggressive therapy than called for in the standard EMS protocol.

The pulmonologist may also offer a new treatment protocol outlining a new and even more aggressive therapy. Using the systems, the pulmonologist may research and retrieve the protocol, follow it and attach it to a summary report.

The pulmonologist may be able to determine exactly where the ambulance and the hospitals are located. The pulmonologist may determine that it would be better to send the patient to the clinic near the patient, where the pulmonologist can then guide the follow-on treatment by telephone or other means.

The pulmonologist may send the summary report and the protocol to the clinic with additional patient care instructions. The report may be sent via the invention and may appear on a computing device located in the clinic. The computing device may alarm and alert the staff of the incoming patient, what has transpired and how to provide follow-up. The pulmonologist may receive an automatic confirmation from the invention that the message was received and accepted at the clinic. Because the pulmonologist requested the identity of the receiving individual, the pulmonologist may also know who is treating the patient.

While this is happening, in accordance with state health department procedures, an entry can be automatically made in the state's Asthma Registry, automatically attaching a reference number so that all aspects of the event could be retrieved for later analysis.

### EXAMPLE 4

A hospital may determine that a shipment of N-95 face masks has been delayed and the current supply may run out soon. Area hospitals may be close to one another and they may normally provide assistance in these types of matters, the usual response is to begin a series of calls to locate a temporary supply. These calls may be time consuming, require multiple calls and often require multiple callbacks to coordinate.

Using certain embodiments of the present invention, rather than start making phone calls, an individual simply records a brief voice-mail message on a computing device asking which hospitals have N-95 face masks and if the hospital can borrow masks. The message may be sent to all the nearby hospitals using a pre-defined local-hospital group distribution list.

Computing devices at each of the facilities on the distribution list may alarm to inform the staff of the incoming communication via the invention. The message may be clear and unambiguous and several hospitals may promptly reply, saying that although existing stocks of face masks are also low, the sending hospital can borrow a small amount.

The individual may send a voice mail to those responding hospitals with supplies, acknowledging the offer of assistance and advising them that a courier is on the way to pick up the supplies. The individual may send another voice mail to the other hospitals without supplies, thanking them and advising that she/he now has what she/he needs and does not need them to set any masks aside.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A system for electronic messaging, the system comprising:
a database; and
a server and memory for executing the steps comprising:
receiving a message created by a sending device;
receiving a prioritization determination from the sending device;
receiving one or more initial receiving device destinations from the sending device;
receiving one or more alternate receiving device destinations from the sending device;
receiving a determination of a plurality of responses to message delivery failures from the sending device;
attaching data to the message;
encrypting the message;
sending the message to the one or more initial receiving device destinations based upon the prioritization determination;
receiving status information from the one or more initial receiving device destinations;
providing a status of the message to the sending device and the one or more initial receiving device destinations;
updating the status of the message to the sending device and the one or more initial receiving device destinations; and
if message delivery failure occurs, sending the message to one or more alternate receiving device destinations upon message delivery failure, receiving status information from the one or more alternate receiving device destinations, providing a status of the message to the sending device and the one or more alternate receiving device destinations, and updating the status of the message to the sending device and the one or more alternate receiving device destinations;
storing message information in the database; and
storing the status of the message in the database.

2. The system of claim 1, further comprising assigning a digital message priority code to the message.

3. The system of claim 1, further comprising assigning a digital message destination/recipient code to the message.

4. The system of claim 1, wherein the database stores date, time and distribution information related to the message and any forwarding and distributing associated with the message.

5. The system of claim 4, wherein the database stores:
(i) time of receiving the message from the sending device;
(ii) time of delivery of the message to the one or more initial receiving devices;
(iii) time of opening of the message by the one or more initial receiving devices; and
(iv) identity of all initial receiving devices associated with the message.

6. The system of claim 4, wherein the database stores:
(i) time of receiving the message from the sending device;
(ii) time of delivery of the message to the one or more alternate receiving devices;
(iii) time of opening of the message by the one or more alternate receiving devices; and
(iv) identity of all alternate receiving devices associated with the message.

7. The system of claim 1, wherein message delivery failure comprises:
(i) failure to send the message;
(ii) failure of the one or more initial receiving devices to receive the message;
(iii) failure of the one or more alternate receiving devices to receive the message;
(iv) failure of the one or more initial receiving devices to open the message; or
(v) failure of the one or more alternate receiving devices to open the message.

8. The system of claim 1, further comprising alerting the sending device of message delivery failure.

9. The system of claim 8, wherein the alerting is auditory alerts.

10. The system of claim 1, further comprising identifying embedded codes in the message related to the message prioritization, determination of a plurality of responses, and encryption.

11. The system of claim 10, further comprising responding the embedded codes.

12. A system for sending and tracking electronic messages, the system comprising:
a processor and memory for executing the steps comprising:
receiving a selection from a user of one or more initial message destinations for a message;
receiving a selection from the user of one or more responses to message delivery failure;
receiving a selection from the user of a message priority;
receiving a selection from the user regarding acknowledgement preferences;
creating the message using the one or more initial message destinations, the one or more responses to message delivery failure, the message priority, and the acknowledgement preferences;
attaching one or more data files to the message;
receiving a notification from the server regarding message delivery to the one or more initial message destinations;
receiving a notification from the server regarding message delivery failures;
communicating with a server for continuously tracking status of the message; and
if requested by the user, receiving an acknowledgement including identification of the receiving user at the one or more initial message destinations.

13. The system of claim 12, further comprising providing a set of status indicators on a control screen indicting that the message has (i) been sent; (ii) been delivered; (iii) been opened by the one or more initial message destinations; and (iv) been acknowledged by the one or more initial message destinations.

14. The system of claim 12, further comprising providing auditory alarms in response to message delivery failures.

15. The system of claim 12, wherein message delivery failure comprises:
(i) failure to send the message;
(ii) failure of the one or more initial message destinations to receive the message;
(iii) failure of one or more alternate message destinations to receive the message;
(iv) failure of the one or more initial message destinations to open the message; or
(v) failure of the one or more alternate message destinations to open the message.

16. The system of claim 12, wherein the one or more responses to message delivery failure comprise one or more alternate message destinations.

17. The system of claim 16, further comprising providing a set of status indicators on a control screen indicting that the message has (i) been sent; (ii) been delivered; (iii) been opened by the one or more alternate message destinations; and (iv) been acknowledged by the one or more alternate message destinations.

18. A system for receiving and tracking electronic messages, the system comprising:
a processor and memory for executing the steps comprising:
receiving a message from a server;
decrypting the message;
announcing the message in accordance with a level of priority embedded within the message;
if requested by an acknowledgement request embedded within the message, sending an acknowledgement to the server;
sending information regarding opening the message to the server;
sending information regarding reading the message to the server;
sending a response to the message to the server; and
receiving status updates regarding the message from the server.

19. The system of claim 18, further comprising providing a set of status indicators on a control screen indicting that (1) the message was received; and (2) reply/forwarded messages sent have (i) been sent; (ii) been delivered; (iii) been opened by another device ; and (iv) been acknowledged by another device.

20. The system of claim 18, wherein the announcing is an auditory alarm.
